(19) United States
(12) Patent Application Publication
(10) Pub. No.: US 2013/0207487 A1
(43) Pub. Date: Aug. 15, 2013

(54) Electromagnetic motor

(71) Applicants: Daniel THERRIAULT, St-Apollinaire (CA); Georges BEAUREGARD, Granby (CA)

(72) Inventors: Daniel THERRIAULT, St-Apollinaire (CA); Georges BEAUREGARD, Granby (CA)

(21) Appl. No.: 13/385,853

(22) Filed: Mar. 12, 2012

(30) Foreign Application Priority Data
Feb. 9, 2012 (CA) 2768055

(51) Int. Cl. H02K 7/075; H02K 33/00; H02K 9/04

(52) U.S. Cl. 310/16; 310/20

(57) ABSTRACT

An electromagnetic motor (20) comprises a number of head cubicules (24,24′,24″,24″′) comprising electromagnets which produce a magnetic charge at the top (45), and a sleeve (49) receiving pistons (26,26′,26″,26′″) at the bottom (47), the pistons actionning a crankshaft (21). At the upper face of each piston a permanent magnet is installed such that its polarity is the same as that of the electromagnetic charge of its corresponding head cubicle. The repulsion created produces a torque moment around the crankshaft which turns the crankshaft thereby the motor.

### BACKGROUND OF THE INVENTION

The present invention belongs to the field of electromagnetic motors comprising a number of head cubicles which produce an electromagnetic charge.

### PRIOR-ART

The present invention refers to a previous canadian patent application CA 2,768,055 “Electromagnetic motor” filed on Feb. 9, 2012 by the same authors.

The following applications drew our attention:

CA 2,441,746 “Magnetic motor” filed on Feb. 27, 2002 by Hosaka, Akira shows a magnetic motor comprising rotors (4,5) provided with permanent magnets (12) and rotatingly disposed about an axis of rotation, a magnetic sensor disposed at the periphery of the rotor; a plurality of electromagnetic coils and means to control the electric current generated from the electromagnetic coils.

U.S. Pat. No. 3,895,245 “Electric motor utilizing permanent magnets” filed on May 23, 1975 and delivered on Jul. 15, 1975 by Bod, Georges F. shows repulsing magnets disposed at the meeting point of counter-rotating disks having intermeshing gearing.

### OBJECTIVES AND ADVANTAGES

There is a need on the market for an electromagnetic motor which can produce mechanical energy with a minimum of intervention.

The present invention comprises a number of head cubicles producing an electromagnetic charge. A crankshaft is actuated by pistons, each upper face thereto comprising a permanent magnet of like polarity to the electromagnetic charge; a repulsion is created by like charges producing a torque moment around the crankshaft thereby allowing the motor to turn or to function.

Our system comprises a combination of:

1) a crankshaft having hollows pistons being attached thereto;

2) the pistons are provided each with a permanent magnet positioned at the upper face thereof, the arm at the bottom of the piston being attached to the crankshaft and each piston is enclosed in a cylinder to produce an up and down movement; and the head of the piston thereupon is free to move within the sleeve of the corresponding head cubicle.

3) Each cubicle contains an electromagnet disposed such that a magnetic charge will be transferred against each piston. The shell or sleeve of the head cubicle is made of aluminum. The cubicles have an aperture to permit the passage of compressed air and suction from the cylinder of the piston; such compressed air will therefore be used as a cooler;

4) an electric system produces an electric current used to charge electromagnetic heads and to amplify the force of attraction or repulsion of the magnetic field produced;

5) the head cubicles and the permanent magnet of the piston are placed such that their similar polarities face each other in order to produce a repulsion.

### DESCRIPTION OF OUR CONCEPT

Pistons are made with a permanent magnet on their upper faces, and they are disposed on a crankshaft and intended to be pushed upwardly towards head cubicles whereupon lie electromagnets.

Each piston is enclosed in a cylinder.

When compared to an electric motor, each piston acts as a rotor and the electromagnetic head as a stator.

The head cubicle located above the piston comprises an aperture to draw compressed air created by the piston projected upwardly by the crankshaft when the piston approaches the head cubicle.

An electric distributor charges the electromagnet to change its polarity and to amplify the force of attraction or repulsion of the magnetic field therefore created.

The present invention will be further understood from the following description with reference to the drawings.

### DRAWING FIGURES

FIG. 1 is a perspective of a crankshaft with pistons.

FIG. 2 is a perspective of a magnetic motor.

FIG. 3 is a perspective of an electromagnetic head.

FIG. 4 is two batteries in a parallel configuration.

FIG. 5 is a perspective of a skeleton cylinder.

In the following description the numbers refer to the different parts of the drawings.

### DETAILED DESCRIPTION OF THE PREFERRED EMBODIMENTS

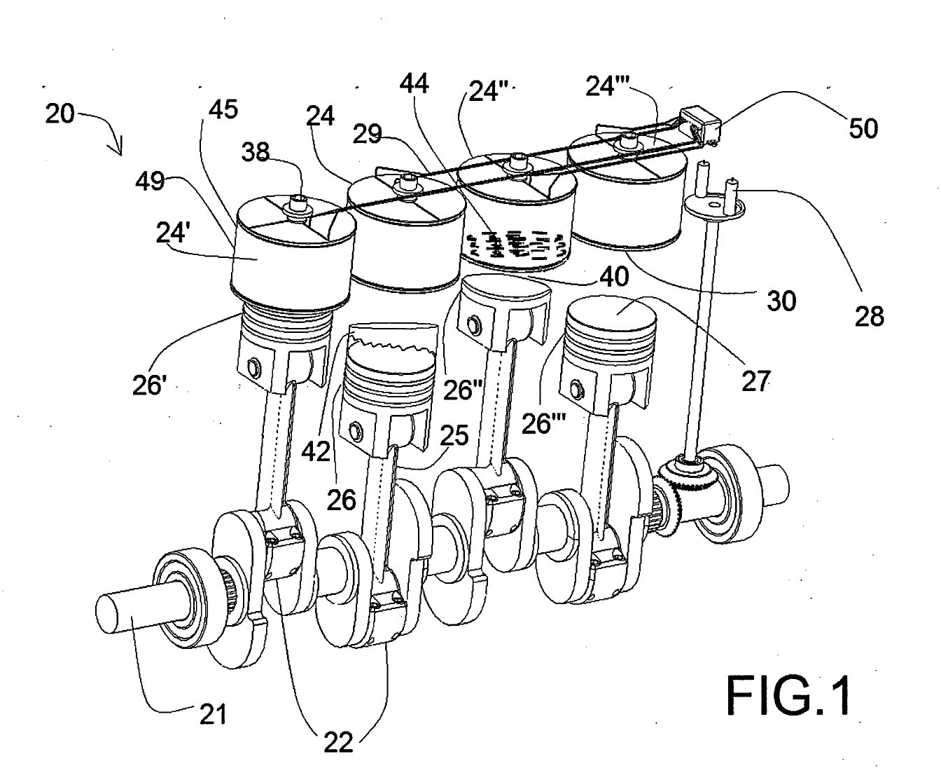

FIG. 1 shows a magnetic system 20 comprising a crankshaft 21 comprising hollows 22 on which are attached arms 25 supporting pistons 26-26″′ enclosed in cylinders 42. On the upper face of the piston there is a permanent magnet 27. Above each piston are head cubicles 24-24′″ enclosing electromagnets 44; in the bottom face of the cubicles there is an aperture 30 to draw compressed air out. The same aperture 30 may be positioned at the top or anywhere within the head cubicle or within the cylinder. A gap 40 between the piston 26″ and the head cubicle 24″ is a limit of a rise of a piston about to receive an impulsion or repulsion charge. The aperture 30 may be located at the top of the cubicle with an open bottom in which case the upper part of the cylinder reaches within the shell-sleeve 49 upwardly as far as the electromagnet. An electric distributor 28 pulses an electric battery 52 current to a control 50 which feeds wire 29 towards the head cubicles. One sees a sleeve 49, a core 38 and top 45 of the cubicle 24′.

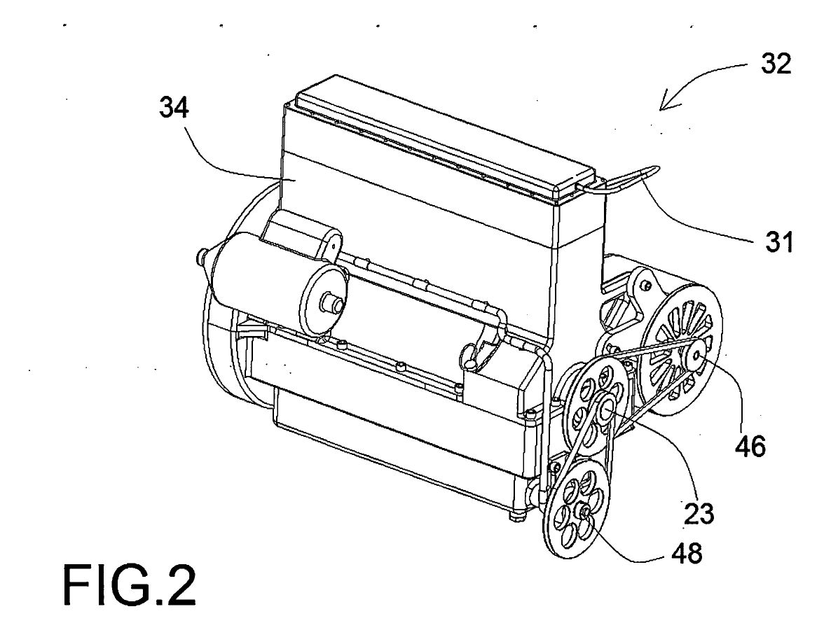

FIG. 2 shows an electromagnetic motor 32 with the magnetic system presented in FIG. 1 inside a block 34. One sees a current cable 31, a slow turn gear 48 the shaft thereof operating an oil pomp for lubricating the crankshaft, a master gear 23 the revolution thereof originating from one end of the crankshaft, the other end of the crankshaft being an output to a transmission and wheels. One sees a high turn gear 46 operating a generator which recharges a battery.

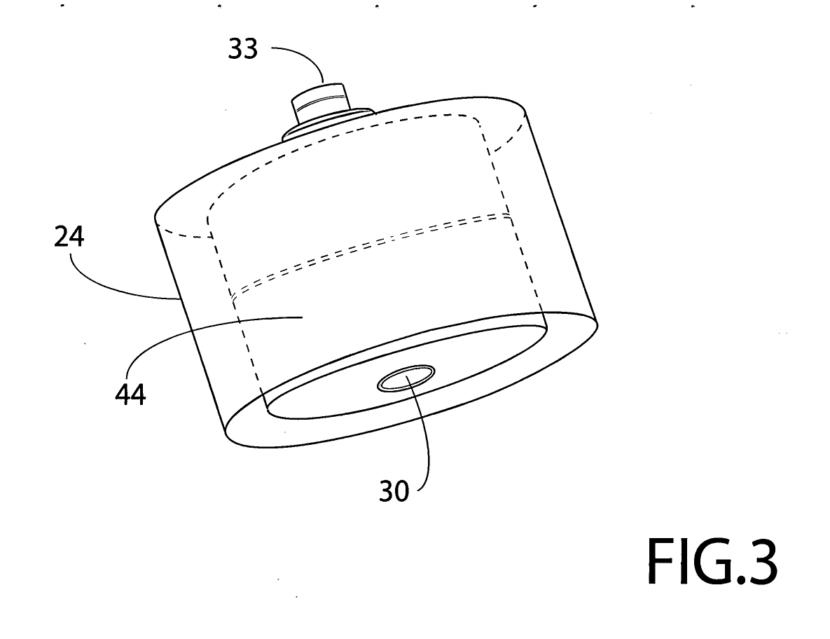

FIG. 3 shows a cylinder 24 in which is inserted a coil of electromagnets 44. The aperture 30 drawing compressed air out is visible, as well a socket 33 allowing electrical wires 29 to charge the electromagnets.

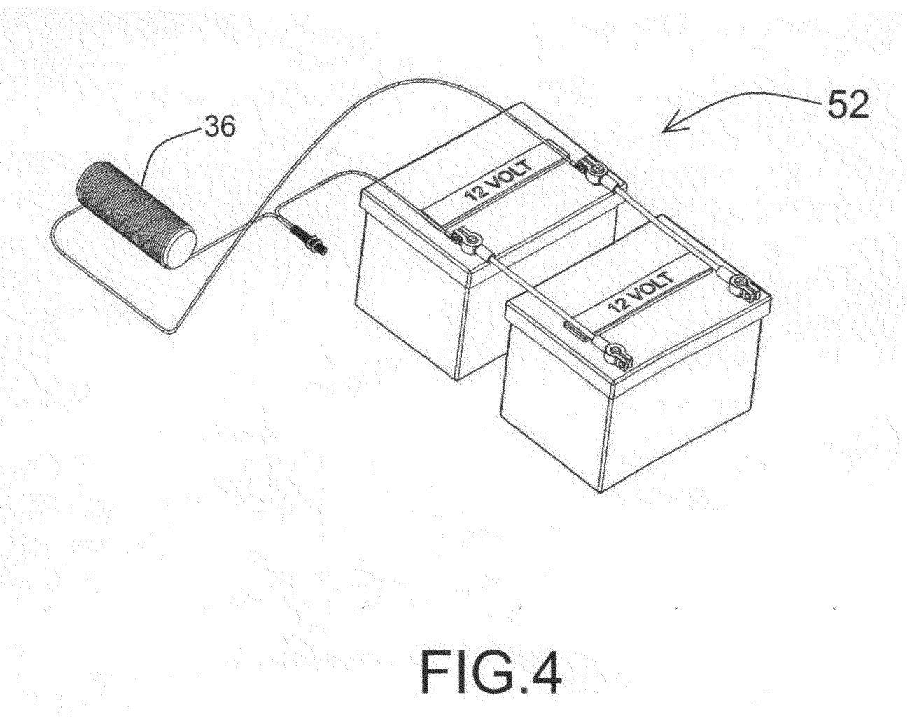

FIG. 4 shows a combination of two batteries in parallel.

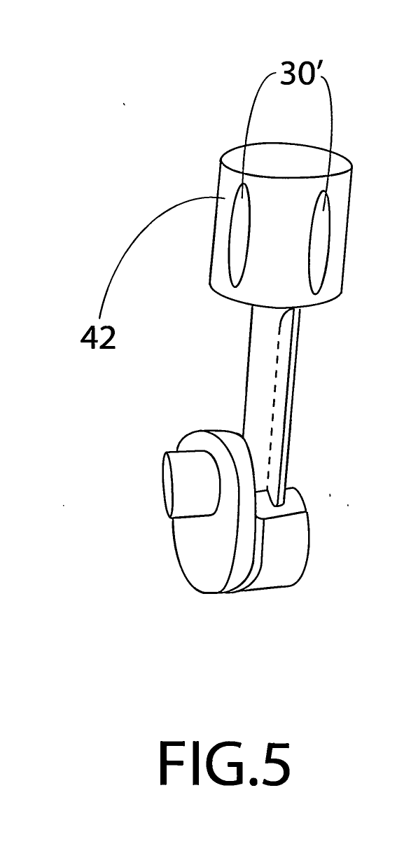

FIG. 5 shows a cylinder 42 with apertures 30′ destined to avoid compression of air while guiding the displacement of the piston.

### SUMMARY

An electromagnetic motor comprising:
a cylinder 42;
crankshaft means 21 connected to the cylinder
a piston 26 mobile in the cylinder, the piston comprising an impact face and an arm 25 connected to the crankshaft means, the impact face comprising a permanent magnet 27 positioned at the face;
head cubicle means 24 placed over the cylinder and comprising an electromagnet positioned opposite the permanent magnet;

means to charge successively the electromagnet, thereby causing a repulsion of the mobile piston causing a movement of the arm against the crankshaft means.

The electromagnetic motor may also comprise at least two cylinders, at least two pistons, and at least two head cubicles and two electromagnets. The two pistons being attached to the crankshaft means in successive hollows, when one of the two pistons is pushed against the crankshaft means in a first hollow by the repulsion produced by a first electromagnet facing the first piston, a second of the two pistons upstanding from a second hollow is pushed upwardly, receiving a second repulsion by the second of the two electromagnets facing the second piston and being pushed back against the crankshaft, thereby propulsing the first piston towards the first electromagnet, and the crankshaft means turning on itself.

The head cubicle means comprise charge coils powered by distributor means 28 powered by battery means.

The distributor may be combined to condenser means intended to increase the force of repulsion, and the crankshaft means thereby turning more rapidly the electromagnetic motor.

The battery comprises a configuration of between 6 and 48 volts, 50 to 1500 amperes, and is destined to a thrust of 400 pounds in a movement of 5 cms, 1000 turns per minute and 15 thrusts per second.

The cylinder may be continuous with the cubicle means, the cubicle means comprising a bottom 47, a sleeve 49 and a top 45 and the piston is displaced from the bottom to the top within the sleeve. The top 45 comprises an aperture 30 destined to release compressed air and suck fresh air in for cooling the electromagnet.

The cylinder is a squeletton with openings 30′ and with a structure comprising ribs to guide an up and down movement of the piston.

It is to be clearly understood that the present description with reference to the attached drawings is made in an indicative manner and that the preferred embodiments described herein are meant in no way to limit further embodiments realizable within the scope of the invention. The matter claimed as inventive and new is limited only by the following claims.

### PARTS

20 Electromagnetic system 52 Battery

21 Crankshaft

22 Hollows

23 Master gear from crankshaft

24,24′,24″,24″′ Head cubicles

25 Arm of the piston

26,26′,26″,26″′ Pistons

27 Permanent magnet

28 Electric distributor

29 Wire

30,30′ Aperture

31 Cable

32 Magnetic motor

33 Socket

34 Block

36 Coil

38 Core

40 Gap

42 Cylinder

44 Electromagnet

45 Top

46 Slow turn gear

47 Bottom

48 High turn gear

49 Sleeve

50 Control

We claim:

1. An electromagnetic motor comprising:
a cylinder (42);
crankshaft means (21)connected to said cylinder
a piston (26) mobile in said cylinder, said piston comprising an impact face and an arm (25) connected to said crankshaft means, said impact face comprising a permanent magnet (27) positioned at said face;
head cubicle means (24) placed over said cylinder and comprising an electromagnet positioned opposite said permanent magnet;
means to charge successively said electromagnet, thereby causing a repulsion of said mobile piston causing a movement of said arm against said crankshaft means.

2. The electromagnetic motor of claim 1, comprising at least two cylinders, at least two pistons, and at least two head cubicles and two electromagnets, said two pistons being attached to said crankshaft means in successive hollows, when one of said two pistons is pushed against said crankshaft means in a first hollow by said repulsion produced by a first electromagnet facing said first piston, a second of said two pistons upstanding from a second hollow is pushed upwardly, receiving a second repulsion by said second of said two electromagnets facing said second piston and being pushed against said crankshaft, thereby propulsing said first piston towards said first electromagnet, and said crankshaft means turning on itself.

3. The electromagnetic motor of claim 1. wherein said head cubicle means comprise charge coils powered by distributor means (28) powered by battery means.

4. The electromagnetic motor of claim 3 wherein said distributor means (28) are combined to condenser means intended to increase said force of repulsion, said crankshaft means thereby turning more rapidly said electromagnetic motor.

5. The electromagnetic motor of claim 4 wherein said battery comprises a configuration of between 6 and 48 volts, 50 to 1500 amperes, and is destined to a thrust of 400 pounds in a movement of 5 cms, 1000 turns per minute and 15 thrusts per second.

6. The electromagnetic motor of claim 1 wherein said cylinder is continuous with said cubicle means, said cubicle means comprising a bottom (47), a sleeve (49) and a top (45) and said piston is displaced from said bottom to said top within said sleeve.

7. The electromagnetic motor of claim 6 wherein said top (45) comprises an aperture (30) destined to release compressed air and suck fresh air in for cooling said electromagnet.

8. The electromagnetic motor of claim 1 wherein said cylinder is a discontinuous squeletton with openings and with a structure comprising ribs to guide an up and down movement of said piston.
